(19) United States
(12) Patent Application Publication
(10) Pub. No.: US 2013/0316729 A1
(43) Pub. Date: Nov. 28, 2013

(54) POSITION INFORMATION MANAGEMENT SYSTEM, POSITION INFORMATION MANAGEMENT METHOD, AND MANAGEMENT SERVER

(71) Applicants: Yasuo OHASHI, Kanagawa (JP); Michitaka FUKUDA, Kanagawa (JP); Shin KUSAKARI, Kanagawa (JP); Seiji MIYAWAKI, Kanagawa (JP); Kunihiro MIYAUCHI, Kanagawa (JP); Satoshi KAWASAKI, Kanagawa (JP); Takaaki HIROI, Tokyo (JP); Shinji AOKI, Kanagawa (JP); Yusuke MATSUSHITA, Kanagawa (JP)

(72) Inventors: Yasuo OHASHI, Kanagawa (JP); Michitaka FUKUDA, Kanagawa (JP); Shin KUSAKARI, Kanagawa (JP); Seiji MIYAWAKI, Kanagawa (JP); Kunihiro MIYAUCHI, Kanagawa (JP); Satoshi KAWASAKI, Kanagawa (JP); Takaaki HIROI, Tokyo (JP); Shinji AOKI, Kanagawa (JP); Yusuke MATSUSHITA, Kanagawa (JP)

(73) Assignee: RICOH COMPANY, LTD., Tokyo (JP)

(21) Appl. No.: 13/864,554

(22) Filed: Apr. 17, 2013

(30) Foreign Application Priority Data
May 25, 2012 (JP) 2012-120204

(51) Int. Cl. H04W 4/02

(52) U.S. Cl. CPC H04W 4/02
USPC 455/456.1

(57) ABSTRACT

A position information management system is disclosed, including a communication apparatus which includes a storage unit which stores therein position information of the communication apparatus; a wireless terminal which includes identification information and which communicates with the communication apparatus; and a management server which manages a position of the wireless terminal, wherein the management server further includes a position information receiving unit which receives the identification information and the position information from the communication apparatus; a storage unit which stores therein the communication apparatus and registered position information of the communication apparatus; a determining unit which determines whether the position information received by the position information receiving unit and stored in the storage unit and the registered position information match; and a management unit which manages a position of the wireless terminal with the identification information and the position information that is determined to match by the determining unit.

### TECHNICAL FIELD

The present invention relates to a position information management system, a position information management method, and a management server.

### BACKGROUND ART

Various position information management systems are being proposed which grasp and manage a position of a wireless terminal, or a person or an article having the wireless terminal in a facility in which an accurate positioning using GPS, etc., is difficult.

Patent document 1 discloses a system in which a passive RF (Radio Frequency) tag attached to a person is read with a fixed RF (Radio Frequency) reader/writer and a position thereof is reported to a different wireless terminal, etc.

Patent document 2 discloses a system in which a wireless terminal converts an identifier which is wirelessly transmitted from a neighboring transmitter to position specifying information to specify an own position.

Patent document 3 discloses a system in which a wireless terminal receives specific information transmitted from a lighting apparatus and transmits the specific information to a server to specify a position of the wireless terminal.

However, with the system in Patent document 1, a large number of RF (Radio Frequency) reader/writers needs to be installed in order to read the passive RF (Radio Frequency) tag with a narrow range in which communications are possible, which may lead to higher cost in implementing the infrastructure.

Moreover, with the system in Patent document 2, power consumption of the wireless terminal may become high depending on a communications scheme between the wireless terminal and a server.

Furthermore, also in the system in Patent document 3, power consumption of the wireless terminal is not taken into account as in Patent document 2. Moreover, in a server, in order to specify the position of the wireless terminal, it is necessary to search a position associated with the specific information, which could lead to a higher computation cost.

### PATENT DOCUMENTS

Patent document 1: JP4620410B

Patent document 2: JP2010-159980A

Patent document 3: WO2005/086375A

### DISCLOSURE OF THE INVENTION

In light of problems as described above, an object of the present invention is to provide an efficient position information management system, etc.

According to an embodiment of the present invention, a position information management system is provided, including a communication apparatus which includes a storage unit which stores therein position information of the communication apparatus; a wireless terminal which includes identification information and which communicates with the communication apparatus; and a management server which manages a position of the wireless terminal, wherein the management server further includes a position information receiving unit which receives the identification information and the position information from the communication apparatus; a storage unit which stores therein the communication apparatus and registered position information of the communication apparatus; a determining unit which determines whether the position information received by the position information receiving unit and stored in the storage unit and the registered position information match; and a management unit which manages a position of the wireless terminal with the identification information and the position information that are determined to match by the determining unit.

According to another embodiment of the present invention, a position information management method in a position information position information management system is provided, including: a communication apparatus which includes a storage unit which stores therein position information of the communication apparatus; a wireless terminal which includes identification information and which communicates with the communication apparatus; and a management server which manages a position of the wireless terminal, wherein the management server further includes the steps of: receiving the identification information and the position information from the communication apparatus; obtaining, from a storage unit which stores therein the communication apparatus and registered position information of the communication apparatus, the registered position information of a communication apparatus which transmitted the position information received by the position information receiving unit and stored in the storage unit; determining whether there is a match between the registered position information and the position information received by the position information receiving unit; and managing a position of the wireless terminal with the identification information and the position information that are determined to match by the determining unit.

According to a further embodiment of the present invention, a management server is provided which is connected with a communication apparatus including a storage unit which stores therein position information of the communication apparatus, and a wireless terminal which includes identification information and which communicates with the communication apparatus, and which manages a position of the wireless terminal, wherein the management server further includes a position information receiving unit which receives the identification information and the position information from the communication apparatus; a storage unit which stores therein the communication apparatus and registered position information of the communication apparatus; a determining unit which determines whether the position information received by the position information receiving unit and stored in the storage unit and the registered position information match; and a management unit which manages a position of the wireless terminal with the identification information and the position information that are determined to match by the determining unit.

Constituting elements, expressions, or an arbitrary combination of constituting elements of the present invention that are applied to a method, an apparatus, a system, a computer program, a recording medium, etc., are also effective as modes of the present invention.

Embodiments of the present invention may provide a position information management system, etc., which efficiently manage position information.

### BRIEF DESCRIPTION OF THE DRAWINGS

Other objects, features, and advantages of the present invention will become more apparent from the following detailed descriptions when read in conjunction with the accompanying drawings, in which:

FIG. 1A is a diagram showing a position information management system according to one embodiment of the present invention;

FIG. 1B is a diagram showing a network which makes up the position information management system according to one embodiment of the present invention;

FIG. 2A is a hardware configuration diagram of a communication apparatus according to one embodiment of the present invention;

FIG. 2B is a hardware configuration diagram of a wireless terminal according to one embodiment of the present invention;

FIG. 2C is a hardware configuration diagram of a management apparatus according to one embodiment of the present invention;

FIG. 2D is a hardware configuration diagram of a management server according to one embodiment of the present invention;

FIG. 3A is a functional block diagram of the communication apparatus according to one embodiment of the present invention;

FIG. 3B is a functional block diagram of the wireless terminal according to one embodiment of the present invention;

FIG. 3C is a functional block diagram of the management apparatus according to one embodiment of the present invention;

FIG. 3D is a functional block diagram of the management server according to one embodiment of the present invention;

FIG. 4 is a diagram showing an example of information held by the communication apparatus according to one embodiment of the present invention;

FIG. 5 is a diagram showing an example of information held by the wireless terminal according to one embodiment of the present invention;

FIG. 6 is a diagram showing an example of a format of position information transmitted by the wireless terminal according to one embodiment of the present invention;

FIG. 7 is a diagram showing an example of information held by the management server according to one embodiment of the present invention;

FIG. 8 is a diagram showing an operational sequence of the position information management system according to one embodiment of the present invention;

FIG. 9A is a diagram showing an example of a search screen of the management server according to one embodiment of the present invention;

FIG. 9B is a diagram showing an example of a search result screen of the management server according to one embodiment of the present invention;

FIG. 10 is a functional block diagram of a management server 160-2 according to embodiment 2;

FIG. 11 is a diagram showing an example of communication apparatus management information 376 according to embodiment 2;

FIG. 12 is a diagram showing an example of an extended format including position information to be transmitted and received between the communication apparatus and the wireless terminal according to embodiment 2;

FIG. 13 is a diagram showing one example of the position information including extension information transmitted from the communication apparatus to the wireless terminal according to embodiment 2;

FIG. 14 is a diagram showing one example of position information and identifying information including the extension information transmitted from the wireless terminal to the communication apparatus according to embodiment 2;

FIG. 15 is a flowchart showing an operation of the management server 160-2 according to embodiment 2;

FIG. 16 is a diagram for explaining an information flow in a position information management system 1 according to embodiment 2; and

FIG. 17 is a diagram showing an example of the extended format including position information to be transmitted and received between the communication apparatus and the wireless terminal according to embodiment 2.

### BEST MODE FOR CARRYING OUT THE INVENTION

### Embodiment 1

Below an embodiment of the present invention is described based on the drawings.

1. System

2. Exemplary hardware configuration

3. Function

4. Operational sequence

(1. System)

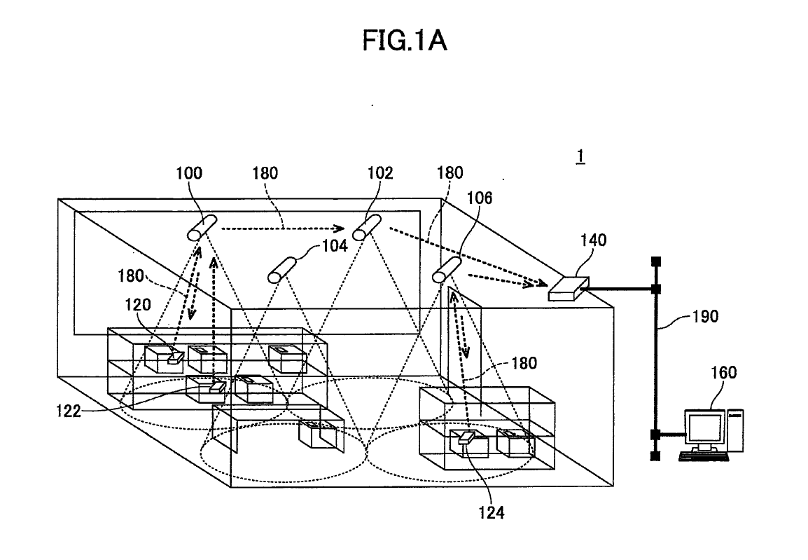

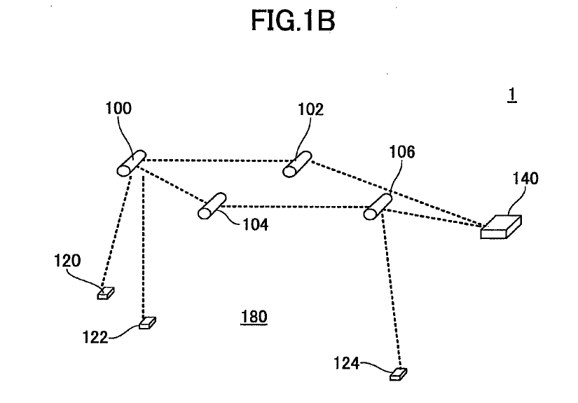

FIG. 1A shows a position information management system 1 according to one embodiment of the present invention. In FIG. 1A are included communication apparatuses 100, 102, 104, 106; wireless terminals 120, 122, 124; a management apparatus 140; a management server 160; a network 180 which includes the communication apparatuses, the wireless terminals, and the management apparatus; and a network 190. Here, the network 180 is a wireless network managed by the management apparatus 140. FIG. 1B shows the communication apparatuses 100, 102, 104, and 106; the wireless terminals 120, 122, 124; and the management apparatus 140, which make up the wireless network in FIG. 1A, being extracted.

The communication apparatuses 100, 102, 104, and 106 that are fixed to a ceiling, etc., of a room, for example, continuously or intermittently transmit wirelessly position information (to be called “position information” below) such as latitude and longitude information, a building floor number, and a building number that is related to a position fixed. The communication apparatuses, which respectively include an independent housing, operate such that power thereof is supplied from a power supply installed in advance, or are embedded in a lighting fixture such as an LED fluorescent tube and operate such that power thereof is supplied from the lighting fixture. The communication apparatuses 100, 102, 104, and 106 transmit position information held respectively thereby to a predetermined range by a wireless signal. The predetermined range is determined by signal strength of a wireless signal used. The communication apparatuses are arranged to cover areas whose positions are to be managed and are configured such that the respective areas do not overlap. Alternatively, they are configured such that any one communication apparatus may be identified based on a strength of a received radio wave on the side which receives the position information even when they overlap. In an example in FIG. 1A, cylindrically-shaped dotted lines which are shown in a lower portion of the respective communication apparatuses show a predetermined range. As a communications scheme which transmits the position information, an indoor messaging system (IMES) may be used, for example.

The wireless terminals 120, 122, and 124 may receive a radio signal transmitted by a nearest communication apparatus out of the communication apparatuses 100, 102, 104, and 106. In the example in FIG. 1A, the respective wireless terminals are attached to a rectangular solid article whose position is to be managed. The wireless terminals 120, 122, and 124 are terminals such as an active tag, etc., which themselves can also transmit radio waves. Below, the wireless terminal 120 is described.

The wireless terminal 120, which is in a range in which a radio signal from the communication apparatus 100 may be received, receives position information of the communication apparatus 100. Receiving of the position information of the communication apparatus 100 is performed by IMES, for example. The wireless terminal 120 transmits to the communication apparatus 100, with position information received, information including own identification information such as a network address, for example. The transmitting is performed via the network 180 by near-field wireless communication such as IEEE 802.15.4 and ZigBee (registered copyright), for example. In this case, as the identification information for the wireless terminal 120, an IEEE extended (MAC) address or an IEEE 802.15.4 short address may be used. The identification information and the position information that are transmitted to the communication apparatus 100 are then transmitted to the management apparatus 140 via the neighboring communication apparatus 102. An operation of transmission and reception in the wireless terminal 120 is performed at a timing which is predetermined in the wireless terminal 120 or at a timing at which a change in acceleration is detected by an acceleration sensor included by the wireless terminal 120.

The management apparatus 140 mutually connects the network 180 and the network 190, and bridges, to the network 190, data transmitted from the network side 180. The management apparatus 140 is installed for each building floor, or for each room separated by a wall, etc., for example. When the network 180 is a PAN (Personal Area Network) by IEEE 802.15.4 and ZigBee (registered copyright) and the network 190 is a LAN based on IEEE 802.3 standards, conversion of communications schemes is performed therebetween. Moreover, when the identification information of the wireless terminal 120 is shown by the IEEE 802.15.4 short address, a conversion is made to the IEEE extended address based on information at the time of configuring the PAN, which converted results are transmitted to the management server 160.

The management server 160 records, with received date and time, the identification information and the position information that are received via the management apparatus 140 and manages a position of the communication apparatus. In the management server 160, an article to be managed that is related to the wireless terminal is recorded in advance. Therefore, these information sets may be used to search for whereabouts of the article to be managed.

The network 180 may be a PAN, which is configured by IEEE 802.15.4 and ZigBee (registered trademark) standards, for example, that connects the respective communication apparatuses 100, 102, 104, and 106; the wireless terminals 120, 122, and 124; and the management apparatus 140. When the PAN is configured by IEEE 802.15.4 and ZigBee (registered trademark) standards, the wireless terminal, the communication apparatus, and the management apparatus respectively include an end device function, a router function, and a coordinator function that are respectively determined by ZigBee (registered trademark) standards. Then, the communication apparatuses and the wireless terminals are subjected to control of the management apparatus at the time of launch, a PAN is configured, and a minimum route to the management apparatus is determined.

The network 190, which is a network connecting the management apparatus 140 and the management server 160, is a LAN determined by the IEEE 802.3 standards, for example.

As described above, in the position information management system 1 according to one embodiment of the present invention, the wireless terminal may use sufficient power to be able to communicate with a nearest communication apparatus to transmit the identification information and the position information to the management server. Moreover, construction of a new infrastructure for installing the communication apparatus is not necessary, making it possible to reduce implementation costs.

The position information of the communication apparatus may be provided via the network 180. In this way, a transmitting unit for transmitting the position information such as IMES becomes unnecessary.

Moreover, when the management apparatus 140 exists nearer relative to the communication apparatus which transmitted the position information, the wireless terminal may transmit the identification information and the position information to the management apparatus 140. In this way, the identification information and the position information may be transmitted to the management server 160 via a shortest route.

Furthermore, functions of the management apparatus 140 may be integrated into the management server 160. In this way, dedicated management apparatuses become unnecessary.

Moreover, the wireless terminal may be a wireless terminal which has an equivalent function as an active tag such as a smart phone, a PDA, a PC, or a smart meter. This makes it possible to manage position information of an existing wireless terminal without attaching a tag.

Furthermore, in addition to the above-described position information, information which specifies a more precise position may be included such as information which shows a section within a room, for example. This makes it possible to perform more precise position management.

Moreover, a target whose position is to be managed may be a person. This makes it possible to manage whereabouts of a person by the system 1.

Furthermore, the network 180 may be configured using a near-field wireless communications such as Bluetooth LE, ANT, Z-Wave, etc., for example. This makes it possible to manage the position information of various wireless terminals.

Moreover, the network 190 may include multiple types of networks such as the Internet, for example. This makes it possible to manage the position information of the wireless terminal regardless of a physical positioning between the network 180 and the management server 160.

(2. Exemplary Hardware Configuration)

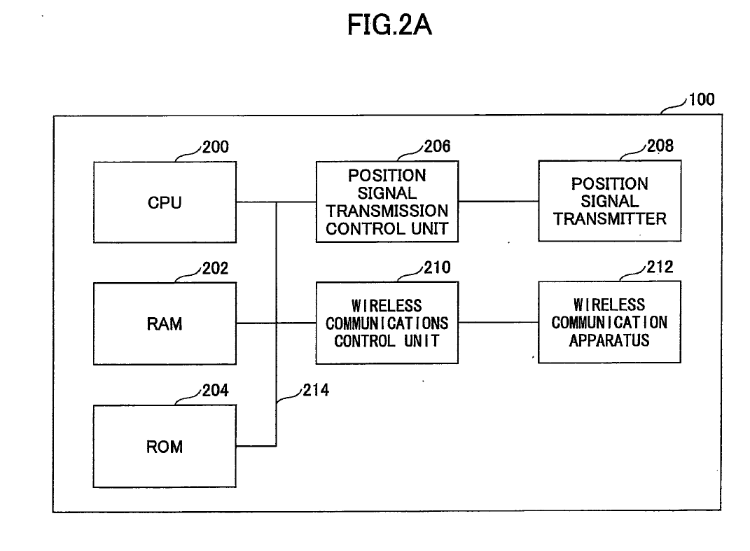

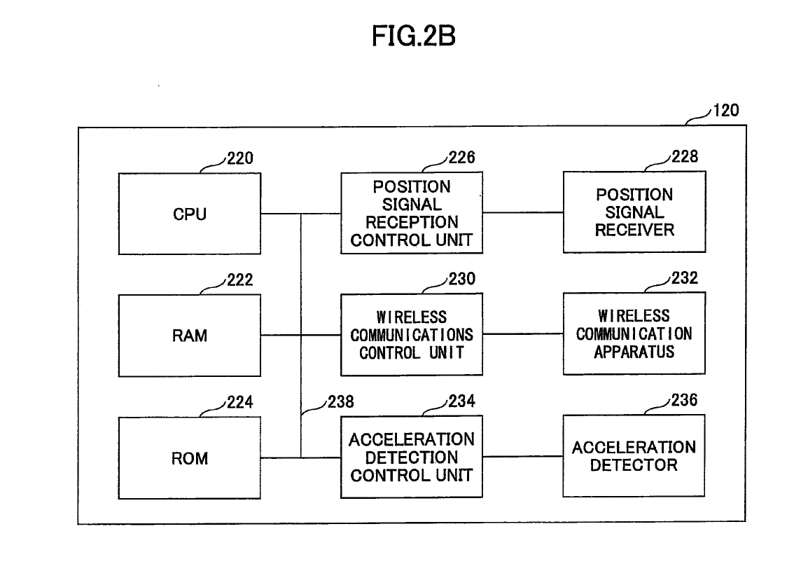

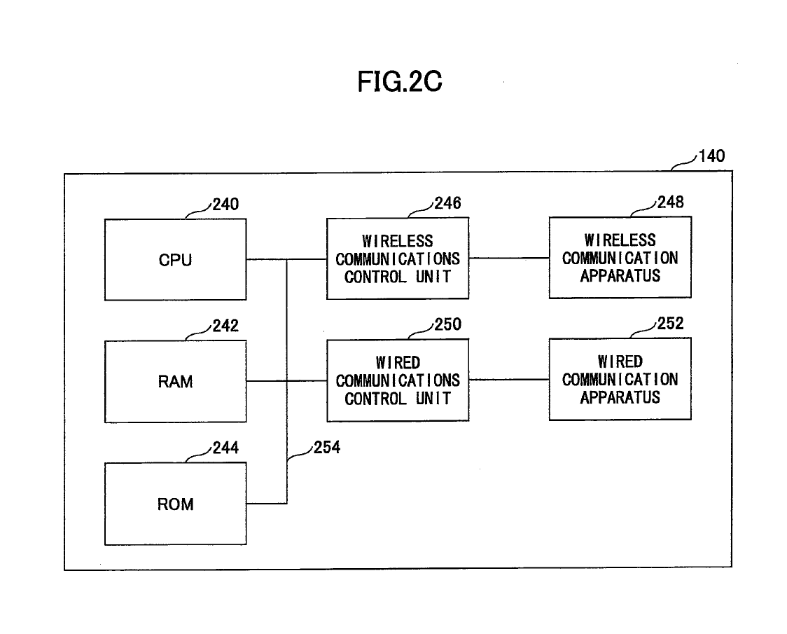

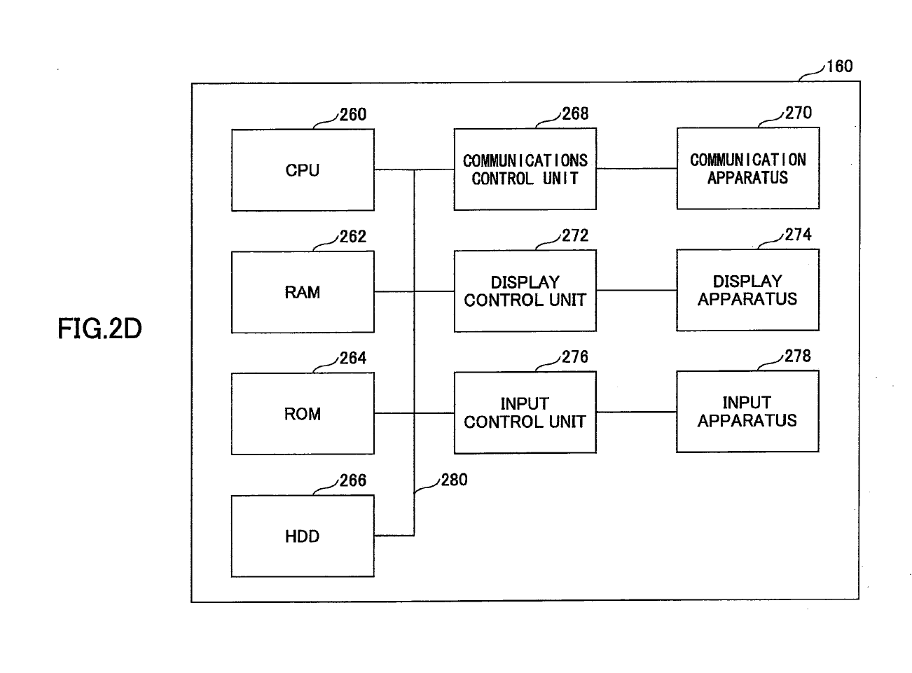

Next, a hardware configuration of the communication apparatus 100, the wireless terminal 120, the management apparatus 140, and the management server 160 that are included in the position information management system 1 are described using FIGS. 2A, 2B, 2C, and 2D.

FIG. 2A shows a hardware configuration of the communication apparatus 100 according to one embodiment of the present invention. The communication apparatus 100 includes a CPU 200, a RAM 202, a ROM 204, a position signal transmission control unit 206, a position signal transmitter 208, a wireless communications control unit 210, a wireless communication apparatus 212, and a bus 214.

The CPU 200 executes programs which perform operational control of the communication apparatus 100. The RAM 202 makes up a work area, etc., of the CPU 200. In addition to the program executed by the CPU 200, the ROM 204 stores position information of the communication apparatus 100. The position signal transmission control unit 206 executes a process for transmitting a positioning signal which shows position information of the communication apparatus 100 via the position signal transmitter 208. The position signal transmitter 208 is an apparatus which includes an antenna for sending a positioning signal such as an IMES, for example. The wireless communications controller 210 executes a wireless communications process via the wireless communication apparatus 212. The wireless communication apparatus 212 is an apparatus including an antenna which can transmit and receive a radio wave which is adapted to IEEE 802.15.4 standards, for example. The bus 214 is electrically connected to the apparatus.

With the above-described configuration, the communication apparatus 100 according to one embodiment of the present invention may transmit the position information to the wireless terminal 120, receive the identification information and the position information from the wireless terminal 120, and transmit these information sets to the management server 160 via the management apparatus 140.

As described above, when the position information is transmitted by wireless communications, the position signal transmission controller 206 and the position signal transmitter 208 become unnecessary.

FIG. 2B shows a hardware configuration of the wireless terminal 120 according to one embodiment of the present invention. The communications terminal 120 includes a CPU 220, a RAM 222, a ROM 224, a position signal reception controller 226, a position signal receiver 228, a wireless communications control unit 230, a wireless communication apparatus 232, an acceleration detection control unit 234, an acceleration detector 236, and a bus 238.

The CPU 220 executes programs which perform operational control of the wireless terminal 120. The RAM 222 makes up a work area, etc., of the CPU 220. In addition to programs executed by the CPU 220, the ROM 224 stores the identification information of the wireless terminal 120 and the position information received from the communication apparatus 100. The position signal reception control unit 226 executes a process for receiving a positioning signal which shows position information via the position signal receiver 228. The position signal receiver 228 is an apparatus including an antenna which receives a positioning signal such as IMES, for example. The wireless communications control unit 230 executes a wireless communications process via the wireless communication apparatus 232. The wireless communication apparatus 232 is an apparatus including an antenna which can transmit and receive a radio wave which is adapted to IEEE 802.15.4 standards, for example. The acceleration detection control unit 234 detects a change in acceleration via the acceleration detector 236. The acceleration detector 236 is a motion sensor which uses an inertial force or magnetism or an acceleration sensor, for example. The bus 238 electrically connects the above-described apparatuses.

With the above-described configuration, the wireless terminal 120 according to one embodiment of the present invention may receive the position information from the communication apparatus 100 and transmit, to the communication apparatus 100, own identification information and the position information. In particular, a transmission or reception operation may be performed at a timing at which the wireless terminal 120 is moved to efficiently transmit the identification information and the position information.

When the wireless terminal 120 is an information terminal such as a smart phone or a PC, there may be provided an input apparatus such as a touch panel, a dial key, a keyboard, a mouse, for example, that accepts an input from a user and an input controller which corresponds thereto. Moreover, there may be provided a display apparatus such as a screen and a corresponding display controller.

Moreover, when the wireless terminal 120 includes a GPS antenna and a corresponding control unit, it may receive a positioning signal using IMES using the antenna and cause it to correspond to the position information management system 1 by only software improvement.

Moreover, the acceleration detection controller 234 and the acceleration detector 236 are arbitrary constituting elements. Without the acceleration detection controller 234 and the acceleration detector 236, an operation of transmission or reception of the wireless terminal 120 is performed at a predetermined interval or time.

Moreover, as described above, when the position information is received by wireless communications, the position signal reception control unit 206 and the position signal receiver 208 become unnecessary.

FIG. 2C shows a hardware configuration of the management apparatus 140 according to one embodiment of the present invention. The management apparatus 140 includes a CPU 240, a RAM 242, a ROM 244, a wireless communications control unit 246, a wireless communication apparatus 248, a wired communications control unit 250, a wired communication apparatus 252, and a bus 254.

The CPU 240 executes programs which perform operational control of the management apparatus 140. The RAM 242 makes up a work area, etc., of the CPU 240. The ROM 244 stores the programs to be executed by the CPU 240 and data to be used by the programs. The wireless communications control unit 246 executes the wireless communications process via the wireless communication apparatus 248. The wireless communication apparatus 248 is an apparatus including an antenna which can transmit and receive a radio wave which is adapted to IEEE 802.15.4 standards, for example. The wired communications control unit 250 executes a communications process in a wired manner via the wired communication apparatus 252. The wired communication apparatus 252 is an apparatus which has a network interface which is adapted to the IEEE 802.3 standards, for example. The bus 254 electrically connects the apparatuses.

With the above-described configuration, the management apparatus 140 according to one embodiment of the present invention may convert a signal from the network 180 which includes the communication apparatus 100 and the wireless terminal 120 into the network 190 which includes the management server 160. Moreover, when the network 180 which makes up the PAN is ZigBee (registered trademark), it may include a function of a coordinator which manages devices which participate in the PAN.

FIG. 2D shows a hardware configuration of the management server 160 according to one embodiment of the present invention. The management server 160 includes the CPU 260, the RAM 262, the ROM 264, the HDD 266, the communications control unit 268, the communication apparatus 270, the display control unit 272, the display apparatus 274, the input control unit 276, the input apparatus 278, and the bus 280.

The CPU 260 executes programs which perform an operational control of the management server 160. The RAM 262 includes a work area, etc., of the CPU 260. The ROM 264 stores programs to be executed by the CPU 260 and data to be used by the programs. The HDD 266 stores information for managing a position of the wireless terminal 120 which is used in the position information management system 1. The communications control unit 268 executes a communications process via the communication apparatus 270. The communication apparatus 270 is an apparatus which includes a network interface which is adapted to IEEE 802.3 standards, for example. The display control unit 272 controls what is to be displayed on the display apparatus 274 according to processing of programs related to position management that are executed on the management server 160. The display apparatus 274 includes a display such as a liquid crystal display or a CRT display, for example. The input control unit 276 processes a signal from the input apparatus 278 such as a keyboard, a mouse, etc., that accepts an input from the user. The bus 280 electrically connects these components.

With the above-described configuration, the management server 160 according to one embodiment of the present invention may manage a position of the wireless terminal 120 and search for whereabouts of the wireless terminal 120.

The HDD 266 may be any storage apparatus including a tape drive, or it may be a storage area which can be accessed via a network.

Moreover, the management server 160 may include a wireless communications control unit and a wireless communication apparatus normally included in the management apparatus 140, and a process thereof may be performed in lieu of the management apparatus 140. This makes it unnecessary to separately provide the management apparatus 140.

(3. Function)

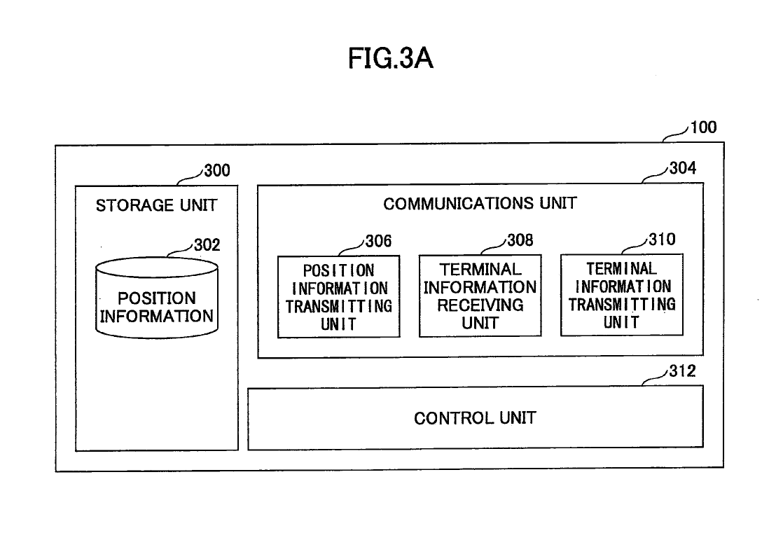

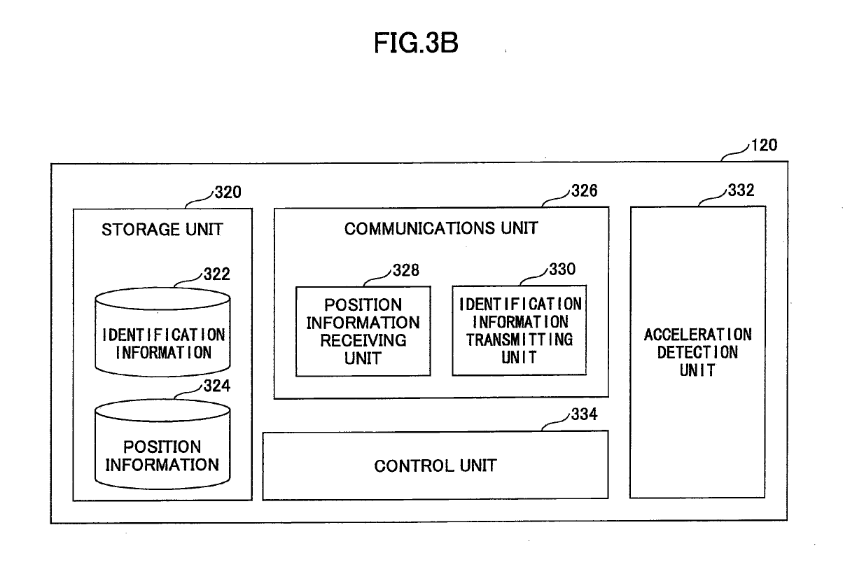

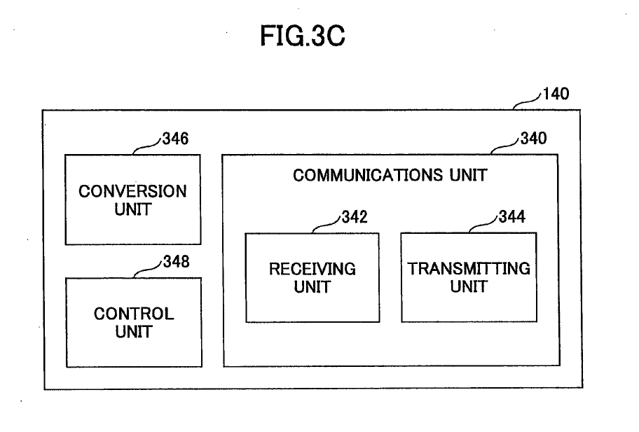

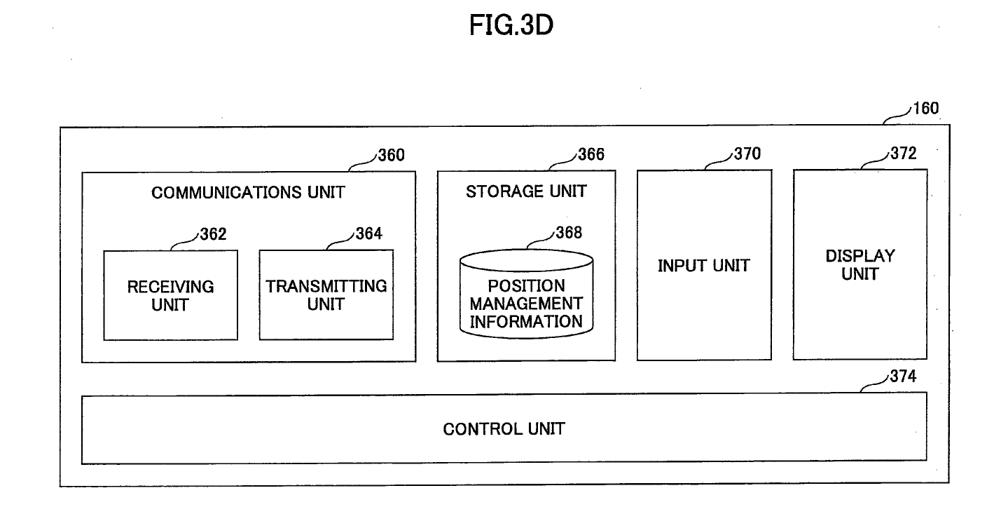

FIG. 3A shows a functional block diagram of the communication apparatus 100 according to one embodiment of the present invention. The communication apparatus 100 according to one embodiment of the present invention includes a storage unit 300, a communications unit 304, and a control unit 312.

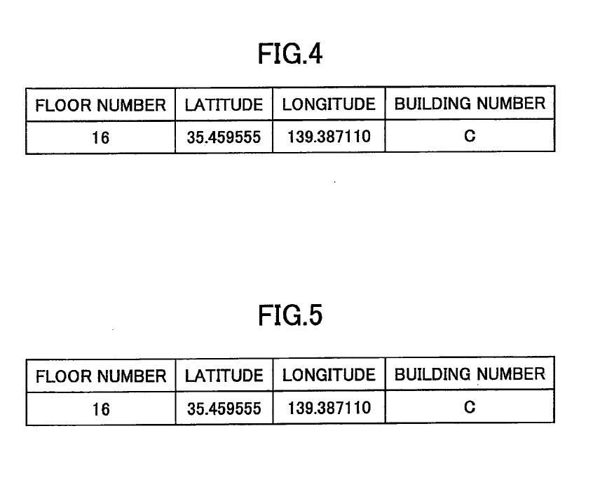

The storage unit 300 stores position information 302 of the communication apparatus 100. An example of a table for storing the position information 302 is shown in FIG. 4. FIG. 4 includes items of the floor number, latitude, longitude, and building number. The floor number shows a floor number of a building on which the communication apparatus 100 is installed. The latitude and the longitude show a latitude and a longitude of a position at which the communication apparatus 100 is located. The building number shows a building number of a building in which the communication apparatus 100 is installed. In an example in FIG. 4, the communication apparatus 100 is located on the 16th floor of a C unit of a certain building and is located at a position which is 35.459555 in latitude and 139.387110 in longitude.

The communications unit 304 includes a position information transmitting unit 306, a terminal information receiving unit 308, and a terminal information transmitting unit 310.

The position information transmitting unit 306 wirelessly transmits in a continuous or intermittent manner, to the wireless terminal 120 in a predetermined range, the position information 302 including information such as latitude and longitude information, the floor number in a building, the building number. The position information 302 is transmitted using a format specified in IMES, for example.

The terminal information receiving unit 308 receives identification information and position information transmitted from the wireless terminal 120.

The terminal information transmission unit 310 transmits, to the management server 160 via the management apparatus 140, the identification information and the position information transmitted from the wireless terminal 120. When the network 180 is provided using ZigBee (registered trademark) standards, the transmission is performed using routing information held by the communication apparatus 100.

The control unit 312 controls an operation of the communication apparatus 100. When the communication apparatus 100 configures a PAN using ZigBee (registered trademark) with the management apparatus 140 and the wireless terminal 120, the control is performed such that the communication apparatus 100 provides a router function.

With the above-described configuration, the communication apparatus 100 according to one embodiment of the present invention may hold position information 302, transmit the position information 302 to the wireless terminal 120, and receive the position information and the identification information of the wireless terminal 120 to transmit the identification information to the management server via the management apparatus 140.

The position information 302 may include additional information such as information showing a section within a room and a name of a building in which a communication apparatus 100 is installed. This makes it possible to perform more precise position management.

FIG. 3B shows a functional block diagram of the wireless terminal 120 according to one embodiment of the present invention. The wireless terminal 120 according to one embodiment of the present invention includes a storage unit 320, a communications unit 326, an acceleration detection unit 332, and a control unit 334.

The storage unit 320 includes identification information 322 and position information 324. The identification information 322 includes information which can specify the wireless terminal 120 on the position information management system 1, such as a network address of the wireless terminal 120. For example, when the network 180 is based on IEEE 802.15.4 and ZigBee (registered trademark) standards, the IEEE 802.15.4 short address or the IEEE extended (MAC) address may be used. The position information 324 is position information 302, which is transmitted from the communication apparatus 100. An example of a table for storing therein the position information 324 is shown in FIG. 5. The configuration is the same as that in FIG. 4.

The communications unit 326 includes the position information receiving unit 328 and the identification information transmitting unit 330.

The position information receiving unit 328 receives the position information 302 transmitted from the communication apparatus 100. The position information 302 received is held in the storage unit 320 of the wireless terminal 120.

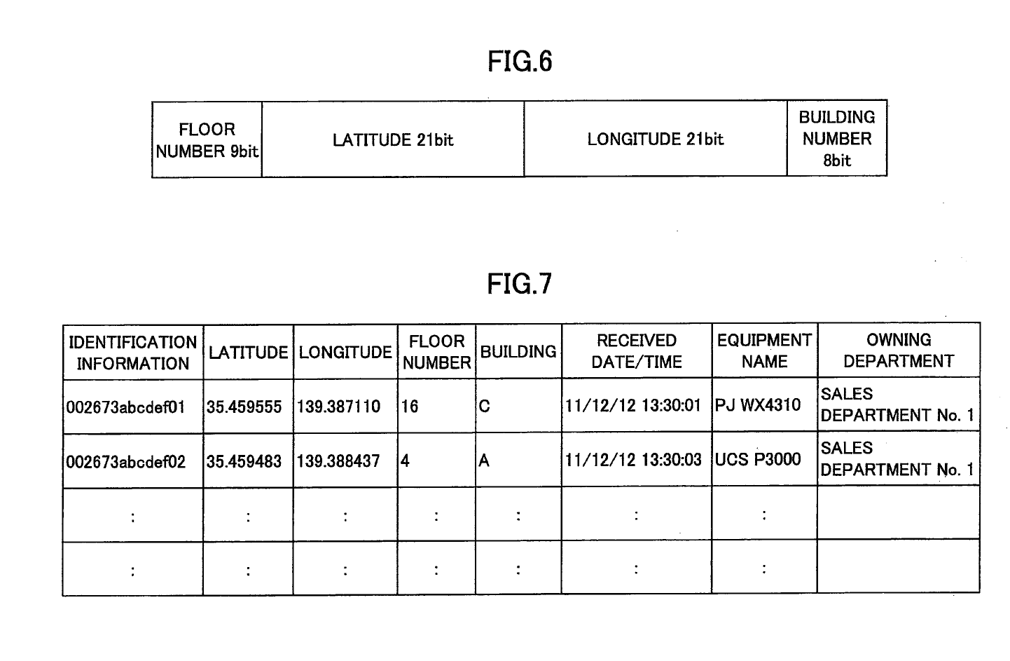

The identification information transmitting unit 330 transmits, to the communication apparatus 100, the position information 324 with the identification information 322 of the wireless terminal 120. The position information 322 is transmitted to the wireless terminal 120 by a format as in FIG. 6, for example. In a format in FIG. 5, respective fields of the floor number, the latitude, the longitude, and the building number that are expressed with 9, 21, 21, and 8 bits, respectively, are formed such that they are linked to an applicable field of a message received according to the IMES standards. An expression format of each field conforms to the IMES standards. In practice, in addition to this format, checksum information and headers which are specified in accordance with communications schemes are added for transmission. As the communications schemes, IEEE 802.15.4 and ZigBee (registered copyright) standards are used, for example.

The acceleration detection unit 332 detects a change in acceleration of the wireless terminal 120. The change in acceleration is detected when the wireless terminal 120 starts a movement, when the movement is stopped, or when a slope is detected. The detected change in the acceleration is used for determining a timing of an operation of transmitting or receiving of the wireless terminal 120. The acceleration detection unit 332 is an arbitrary constituting element.

The control unit 334 controls a timing of receiving position information by the position information receiving unit 228 and a timing of transmitting the position information 324 and the identification information 322 by the identification information transmitting unit 330. The timings of transmitting and receiving are determined based on detection of a change in acceleration by the acceleration detecting unit 332. Alternatively, it may be determined based on an interval or a time set in advance to the wireless terminal 120. Moreover, the timings of transmitting and receiving may be determined independent of each other. Furthermore, when the wireless terminal 120 configures the PAN by ZigBee (registered trademark) with the communication apparatus 100 and the management apparatus 140, control is performed such that the wireless terminal 120 provides an endpoint function.

With the above-described configuration, the wireless terminal 120 according to one embodiment of the present invention efficiently receives position information from a communication apparatus and efficiently transmit it with the other information to the identification information communication apparatus.

When the wireless terminal 120 is an information terminal such as a smart phone or a PC, an input unit which accepts an input from a user or a display unit which presents information to the user may be provided. This makes it possible to present identification information or position information to the user and to input or modify identification information or position information from the user.

FIG. 3C is a functional block diagram of the management apparatus 140 according to one embodiment of the present invention. The management apparatus 140 in one embodiment of the present invention includes a communications unit 340, a conversion unit 346, and a control unit 348.

The communications unit 340 includes a receiving unit 342 and a transmitting unit 344. The receiving unit 342 receives data transmitted from the wireless terminal or the communication apparatus which belongs to the network 180. The transmitting unit 344 transmits the data converted in the management apparatus 140 to the management server 160 which belongs to the network 190. The network 180 is a PAN based on IEEE 802.15.4 and ZigBee (registered trademark) standards, for example. Moreover, the network 190 is a LAN based on IEEE 802.3 standards, for example.

The conversion unit 346 converts data received from the network 180 by the receiving unit 342 to a format which is adapted to the network 190. The converted data are transmitted to the management server 160 via the network 190 by the transmitting unit 344. Here, when the identification information of the wireless terminal 120 that is included in the data is expressed in the IEEE 802.15.4 short address, it is converted to an IEEE extended address based on information at the time of configuring the PAN.

The control unit 348 controls an operation of the management apparatus 140. When the management apparatus 140 configures a PAN by ZigBee (registered trademark) standards with the communication apparatus 100 and the wireless terminal 120, control is performed such that the management apparatus 140 provides a coordinator function.

With the above-described configuration, the management apparatus 140 according to one embodiment of the present invention may bridge communications between the network 180 to which the communication apparatus 100 and the wireless terminal 120 belong and a network 190 to which the management server belongs.

FIG. 3D shows a functional block diagram of the management server 160 according to one embodiment of the present invention. The management server 160 according to one embodiment of the present invention includes a communications unit 360, a storage unit 366, an input unit 370, a display unit 372, and a control unit 374.

The communications unit 360 includes a receiving unit 362 and a transmitting unit 364. The receiving unit 362 receives identification information and position information transmitted from the wireless terminal through the management apparatus 140. The received identification information and position information are stored in the storage unit 366. When requested to provide the position information to an external server, etc., the transmitting unit 364 transmits the position information to the external server, etc.

The storage unit 366 includes position management information 368. The position management information 368 is information in which management information such as received time, etc., is added to the identification information and the position information that are received from the wireless terminal 120. An example of a table storing therein the information is shown in FIG. 7. FIG. 7 includes items of identification information, equipment name, owning department, latitude, longitude, floor number, building, and received date/time. Identification information is information such as an IEEE extended address, for example, of the wireless terminal 120 which transmitted the identification information. The latitude, longitude, floor number, and the building correspond to the position information received with the identification information. The received date/time are date and time at which the management server 160 received the information. The equipment name is a name of an equipment unit of the wireless terminal 120 or a name of a unit to be managed that is assigned to the wireless terminal 120 which transmitted the information. The owning department is a name of a department which owns the wireless terminal 120 which transmitted the information. The information of the equipment name and the owning department are associated with the identification information by the management server 160 in advance.

In order for a user to search for the position information, the input unit 370 accepts an input from the user.

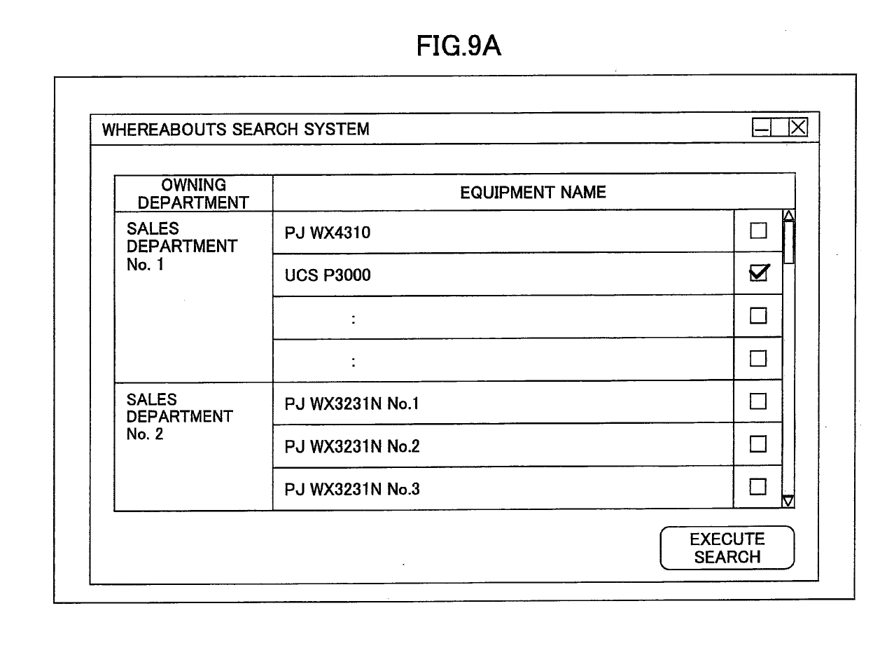

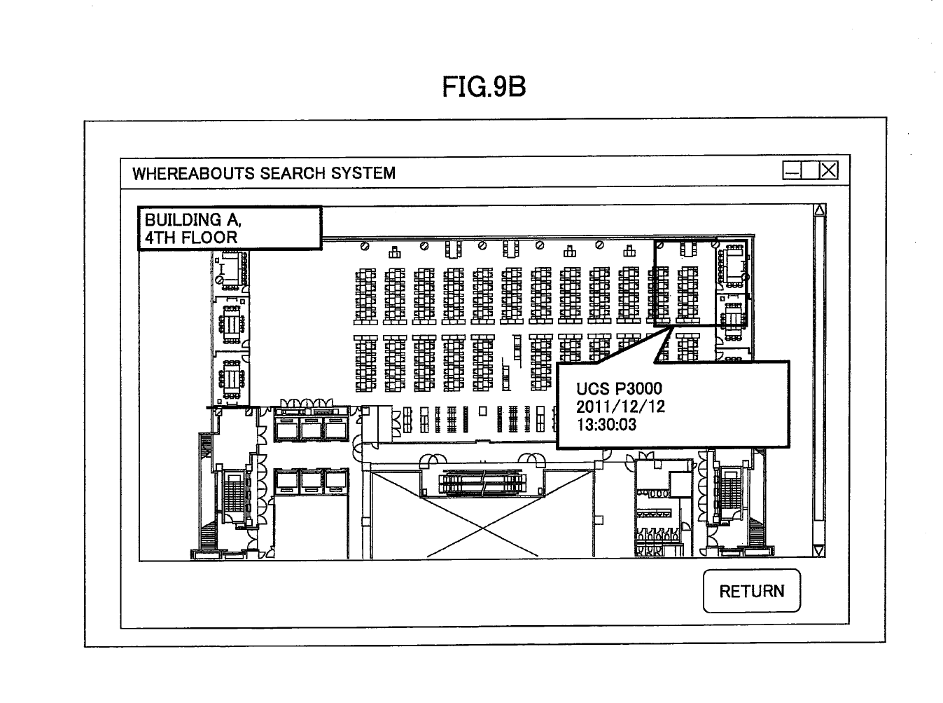

The display unit 372 displays, on a screen, a GUI related to a search screen for the user to search for the position information. An example of the search screen is shown in FIG. 9A. In “a whereabouts search system” shown in FIG. 9A, an owning department and an equipment name that are related to the wireless terminal are displayed in a list on a screen based on information stored in the storage unit 366. When the user selects via the input unit 370 a check box for an equipment unit to be searched for, a check mark is assigned. When “a search execution” button is selected after placing check marks for all equipment units to be searched for, a search is executed, switching to a screen for displaying results. In an example in FIG. 9A, an example in which a user executes a search is shown for an equipment unit of “UCS P3000”, which is owned by “Sales No. 1 Department”. FIG. 9B is an example of a screen of the search results. When “a search execution” button is selected, based on data stored in the storage unit 366, the display unit 372 displays a floor plan of “A building 4th floor” on which “UCS P3000” is located, a name of an equipment unit thereof, and received date/time.

The control unit 374 controls an operation of the management server 160.

With the above-described configuration, the management server 160 according to one embodiment of the present invention may manage a position of the wireless terminal and search for whereabouts thereof. In particular, information itself which shows the position itself of the wireless terminal may be received directly to manage it, making it possible to reduce a computational complexity associated with the search for the position.

The management server 160 may include the same functions as those of the receiving unit 342, the control unit 348, and the conversion unit 346 included by the management apparatus 140 and may include the same functions as the management apparatus 140. This makes it unnecessary to individually provide the management apparatus 140.

Moreover, the position management information 368 which is stored by the management server 160 may store information including an electric field strength or a time taken for arrival of information, identifier of management apparatus or communication apparatus passed through, and date/time at which the wireless terminal transmitted the information, together with or in lieu of information shown in FIG. 7. In this way, position information may be managed under more precise conditions.

Moreover, the management server 160 may record previous position information of the wireless terminal. In this way, a movement of the wireless terminal may be tracked.

(4. Operational Sequence)

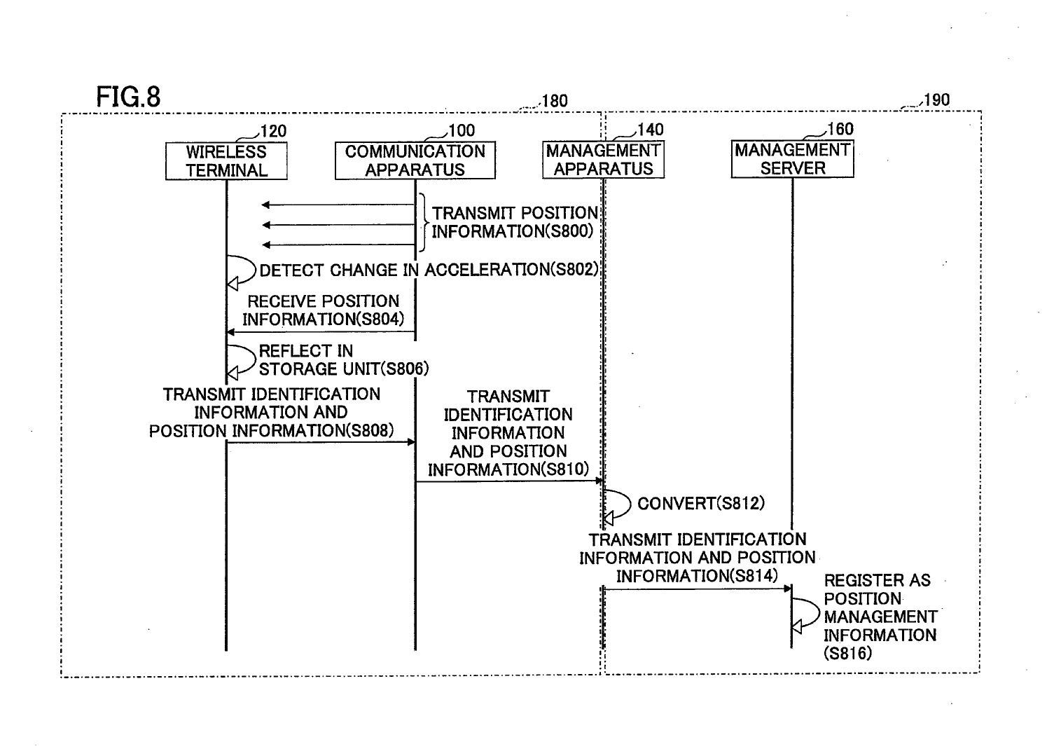

FIG. 8 is a diagram showing an operational sequence of the position information management system 1 according to one embodiment of the present invention in a configuration in FIGS. 1A and 1B. In FIG. 8 is shown an example which includes the communication apparatus 100 which, upon sensing a change in acceleration, receives the position information and transmits the identification information; the wireless terminal 120 which transmits the position information to an area to which the communication apparatus 100 belongs; the management apparatus 140 which bridges a PAN (IEEE 802.15.4 and ZigBee (registered copyright)) and a LAN (IEEE 802.3); and the management server 160. The PAN between the communication apparatus 100, the wireless terminal 120, and the management apparatus 140 is to be already established.

In step S800, the communication apparatus 100 consecutively or intermittently transmits the position information using IMES, etc.

In step S802, the wireless terminal 120 senses a change in acceleration.

In step S804, the wireless terminal 120 receives the position information transmitted from the communication apparatus 100.

In step S806, the wireless terminal 120 stores the position information received.

In step S808, the wireless terminal 120 transmits the identification information and the position information to the communication apparatus 100.

In step S810, the communication apparatus 100 transmits the identification information and the position information received from the wireless terminal 120 to the management apparatus 140 via a minimum route.

In step S812, the management apparatus 140 converts data transmitted from the network 180 that include the identification information and the position information received from the communication apparatus 100 to a format adapted to the network 190.

In step S814, the management apparatus 140 transmits, to the management server 160, the identification information and the position information that are converted to a format adapted to the network 190.

In step S816, the management server 160 registers the identification information and the position information received from the management apparatus 140, together with information on the wireless terminal that corresponds to the identification information.

With the above-described procedure, in the position information management system 1 according to one embodiment of the present invention, a wireless terminal may efficiently transmit the identification information and the location information to a nearby communication apparatus to suppress power consumption of the wireless terminal.

As described above, the management server 160 may execute a function of the management apparatus 140 in an integrated manner. In this case, it becomes unnecessary to separately install the management apparatus 140.

Moreover, when the wireless terminal is not provided with the acceleration detecting unit 332, step S802 is not executed and reception of the position information in step S804 may be performed at a predetermined time or a predetermined interval. The subsequent process is the same as in steps S806-S816.

### Embodiment 2

Next, Embodiment 2 is described.

According to the above-described embodiment, as shown in FIG. 3A, for example, the communication apparatus 100 stores the position information 302 of the communication apparatus 100 in the storage unit 300 (the ROM 204). Moreover, the position information 302 includes items of floor number, latitude, longitude, building number, etc. (see FIG. 4, for example).

Moreover, this position information 302 is to be used for eventually specifying a position in which the wireless terminal 120 exists on the management server 160 via wireless transmission, etc., to the wireless terminal 120 in a predetermined range.

Therefore, in order to for authenticity of the position in which the wireless terminal 120 exists is secured, the position information which is stored in the storage unit 300 of the communication apparatus 100 and properly stored by an administrator, etc., must not be rewritten (must not be manipulated).

Then, in the present Embodiment 2, in order for the authenticity of the position in which the wireless terminal 120 exists to be secured, the communication apparatus 100 is installed by being attached to the ceiling, etc., and then the position information which indicates the installed position is properly set (held) in the storage unit 300 of the communication apparatus 100 by the administrator, etc., after which it is determined whether the position information 302 has been rewritten.

This makes it possible to further improve authenticity of the position information transmitted by the communication apparatus 100, authenticity of the position in which the wireless terminal 120 exists, and reliability as a system of the position information management system 1. Below a detailed explanation is provided.

(Function of Management Server 160-2)

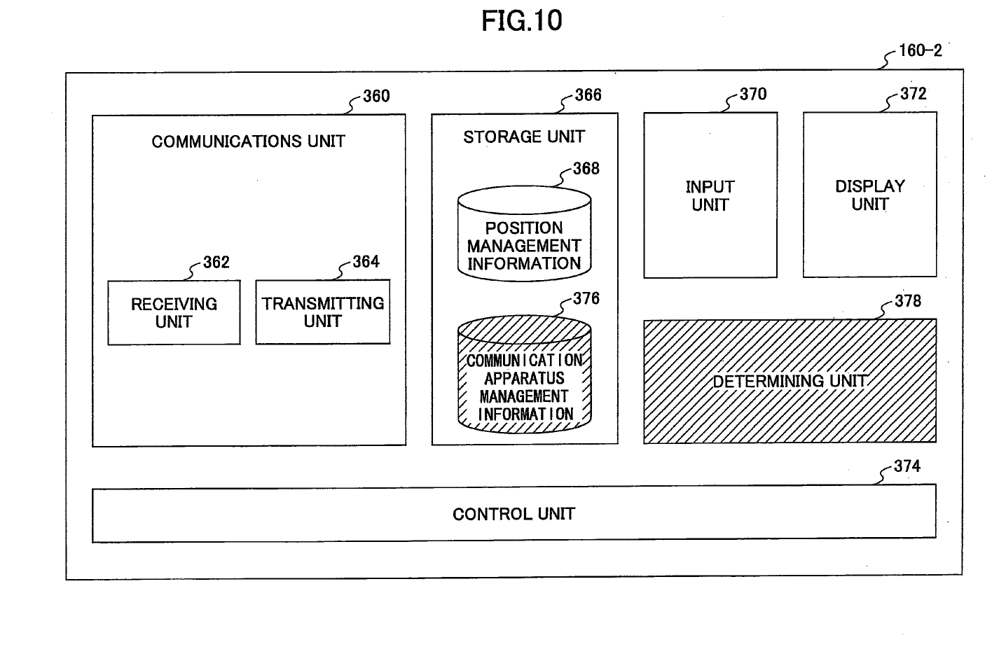

FIG. 10 shows a functional block diagram of a management server 160-2 according to Embodiment 2. Compared to FIG. 3D, the management server 160-2 includes communication apparatus management information 376 in the storage unit 366. Moreover, it includes a determining unit 378.

When the position information and the identification information are received from the wireless terminal 120, the determining unit 378 refers to the communication apparatus management information 376 to determine whether the received position information is authentic position information. Details of these points will be described below.

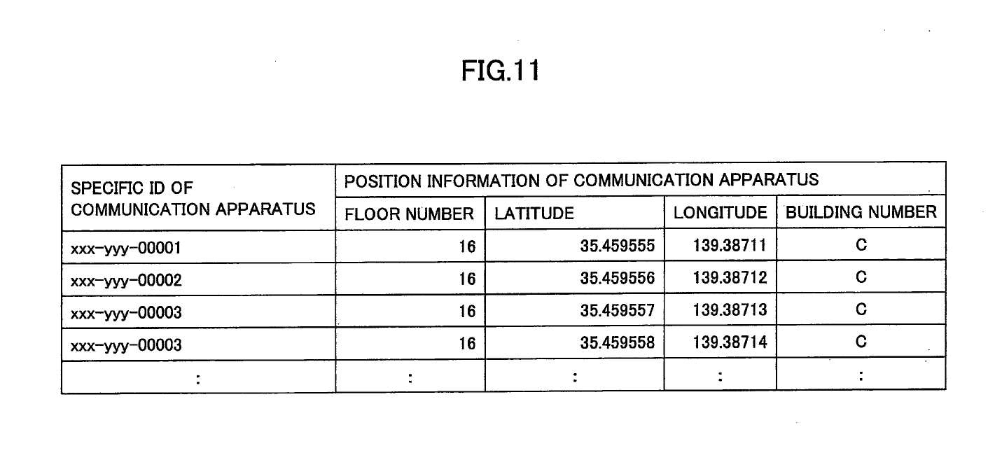

FIG. 11 is a diagram illustrating one example of the communication apparatus management information 376 according to Embodiment 2. In the communication apparatus management information 376 is stored in advance information of communication apparatuses which make up the position information management system 1 (may also be called communication apparatuses which are under control of the management server 160-2) and the position information of the communication apparatuses.

On the communication apparatus management information 376, the communication apparatus is specified by a specific identifier such as a specific ID (a serial number, etc.), for example. Moreover, for each communication apparatus, position information stored in the storage unit 300 of the communication apparatus is collated.

As described above, respective position information sets are stored by an administrator, etc., in each communication apparatus. Then, the administrator, etc., perform a task of registering in advance on the communication apparatus management information 376 position information actually stored for each communication apparatus in operating the position information management system 1.

More specifically, as shown, the communication apparatus management information 376 includes items of position information (including floor number, latitude, longitude, and building number) of the communication apparatus, and a fixed ID of the communication apparatus. For example, for a communication apparatus specified by “specific ID”: xxx-yyy-0001, as position information stored in the storage unit 300 of the communication apparatus is stored (set) the floor number (16), latitude (35.459555), longitude (139.38711), and building number (C). The position information of this communication apparatus is determined for its trustworthiness by an administrator, etc., and is authenticated.

Whenever position information stored in the storage unit 300 of the communication apparatus is subsequently changed or rewritten, the administrator, etc., always update the communication apparatus management information 376 on the management server 160-2 as well.

(Example of Extended Format)

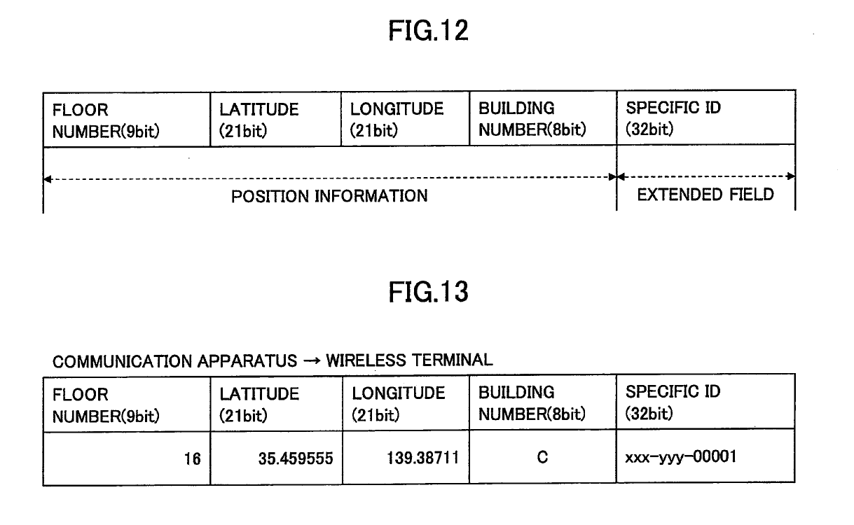

FIG. 12 is a diagram showing an example of an extended format including position information transmitted and received between the communication apparatus and the wireless terminal in Embodiment 2. As seen from a comparison in FIGS. 4 and 5, in the extended format, in addition to the floor number, the latitude, the longitude, and the building number, the respective fields of “the specific ID” are expressed in 9 bits, 21 bits, 21 bits, 8 bits, and 32 bits. An expression format of each field complies with IMES standards.

FIG. 13 is a diagram showing one example of position information which includes extension information transmitted from the communication apparatus to the wireless terminal 120 in Embodiment 2. As shown, from the communication apparatus 100 to the wireless terminal 120, when the position information 302 is transmitted based on an extended format of FIG. 12, the extended format includes extension information (“specific ID”, for example), so that, in addition to the position information, the extension information is also transmitted from the communication apparatus 100 to the wireless terminal 120, resulting in the same information to be held also on the wireless terminal 120 side.

“The specific ID” stored in the extension information is a specific identifier such as a serial ID, etc., of the communication apparatus. When the communication apparatus 100 transmits the location information 302 to the wireless terminal 120, a specific ID of the communication apparatus is set to “the specific ID” field and transmitted by the position information transmitting unit 306 of the communication apparatus (FIG. 10).

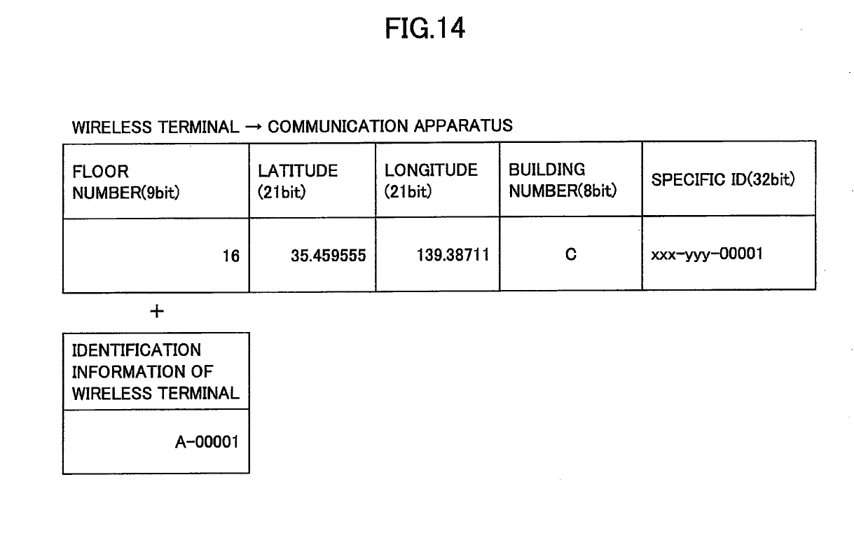

FIG. 14 is a diagram showing one example of the position information and the identification information including extension information transmitted from the wireless terminal 120 to the communication apparatus in Embodiment 2.

As described above, when the wireless terminal 120 receives the position information 302 transmitted from the communication apparatus 100 by the position information receiving unit 328, it holds the received position information 302 (position information 324) in the storage unit 320 of the wireless terminal 120. Then, the position information 324, together with the identification information 322 of the wireless terminal 120, is also transmitted to the communication apparatus 100 by the identification information transmitting unit 330.

Then, the position information 302 from the communication apparatus 100 is being transmitted in an extended format, so that “specific ID” is included in an extended format within a format. Thus, “specific ID” is also included in the position information transmitted from the wireless terminal 120 to the communication apparatus 100. Then finally, the identification information and the position information are transmitted to the management server 160.

(Operation of Management Server 160-2)

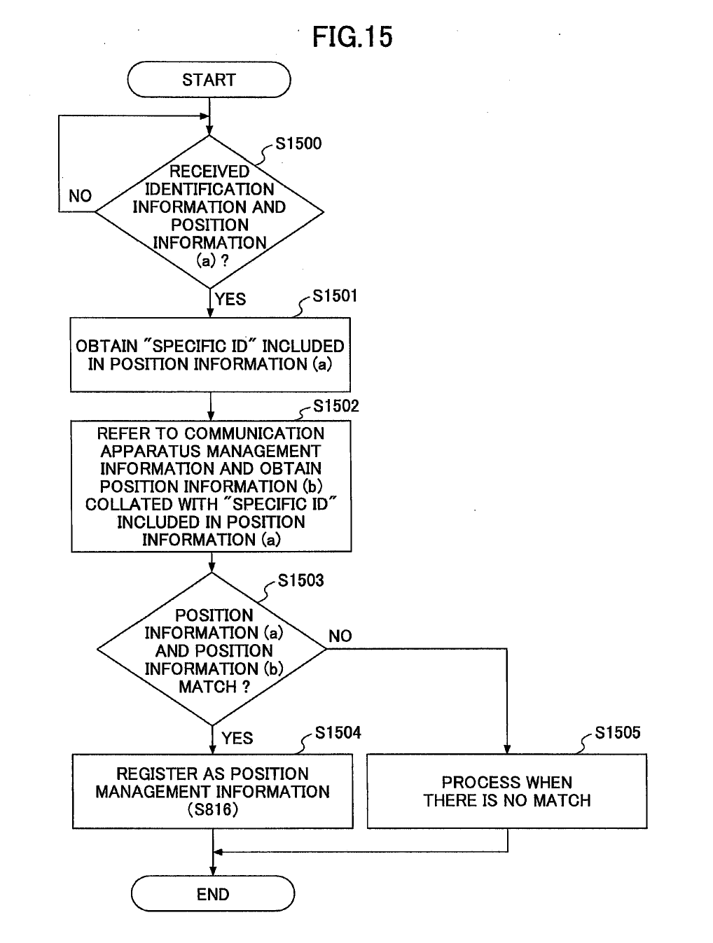

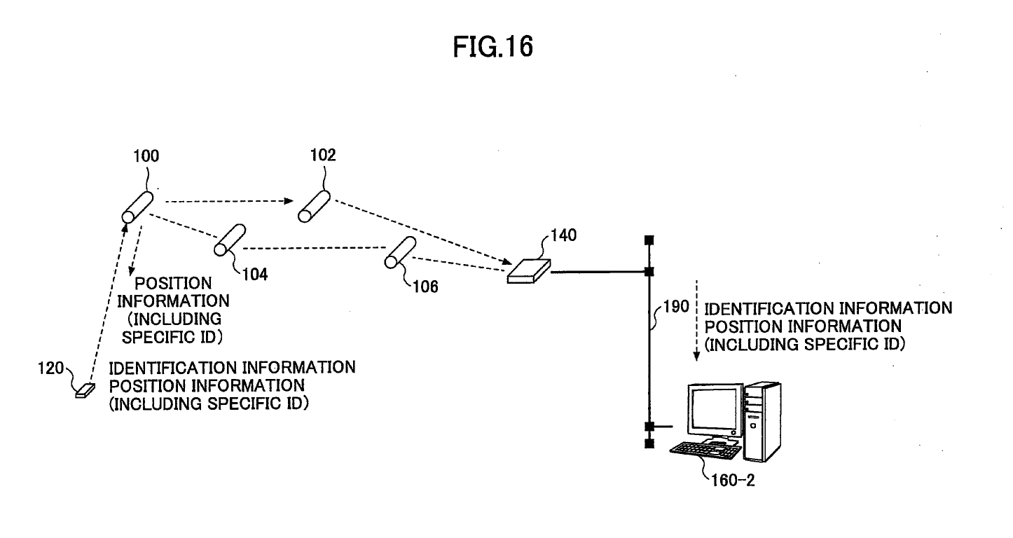

FIG. 15 is a flowchart showing an operation of the management server 160-2 according to Embodiment 2. Moreover, FIG. 16 is a diagram explaining a flow of information in the position information management system 1 according to Embodiment 2.

A timing at which the flowchart begins is a time at which the management server 160-2 receives the identification information and the position information transmitted from the wireless terminal 120. In other words, first, the communication apparatus 100 continuously or intermittently transmits the position information using IMES, etc. The wireless terminal 120 receives the position information 302 from the communication apparatus 100 attached to the ceiling, etc. The wireless terminal 120 stores the position information 324 received and transmits, to the communication apparatus 100, the identification information 322 and the position information 324. Then, finally, the identification information 322 and the position information 324 are received by the management server 160-2. Below, operations of the management server 160-2 are explained in steps.

In step S1500, the receiving unit 362 of the management server 160-2 determines whether it received the identification information and the position information (to be called the position information (a)) transmitted from the wireless terminal 120.

For example, when the communication apparatus 100 is installed on the ceiling, etc., the wireless terminal 120 receives the position information 302 from the communication apparatus 100 when it is positioned in a range in which the position information arrives. Moreover, the wireless terminal 120 transmits, to the communication apparatus 100, the position information 324 with the identification information 322 of the wireless terminal 120. Then, finally, the management server 160-2 is to receive the identification information 322 and the position information 324 that are transmitted from the wireless terminal 120 through the management apparatus 140.

Here, the management server 160-2, for example, receives the identification information and the position information shown in FIG. 14. In other words, as the position information (a), the floor number 16; the latitude 35.459555; the longitude 139.38711; the building number C; (and “specific ID”: xxx-yyy-00001) are received.

In step S1501, the determining unit 378 of the management server 160-2 obtains “specific ID” included in the position information 324 received. Here, for example, “specific ID”: xxx-yyy-00001 is to be obtained.

As described above, with respect to this position information 324, the position information is received based on an extended format, so that the position information 324 includes “specific ID”, which is extension information (FIG. 14). Moreover, the “specific ID” is a specific ID of the communication apparatus 100 near which the wireless terminal 120 is positioned.

In step S1502, the determining unit 378 refers to the communication apparatus management information 376, and obtains position information (to be called position information (b)), which is collated with “specific ID” included in the received position information.

More specifically, with reference to FIG. 11, as position information (b) collated with “specific ID”: xxx-yyy-00001, which is included in the received position information 324, the floor number (16), the latitude (35.459555), the longitude (139.38711), and the building number (C) are obtained.

In step S1503, the determining unit 378 compares and matches the position information (a) and the position information (b) and determines whether they match.

Here, the position information (a) is the position information 324, which is transmitted from the wireless terminal 120, and is originally the position information 302, which is stored in the storage unit 300 of the communication apparatus 100. On the other hand, the position information (b) is position information which is registered in the communication apparatus management information 376, so that it corresponds to the position information 302 stored in the storage unit 300 of the communication apparatus 100 for which authenticity is secured.

Therefore, when the position information (a) and the position information (b) match, the determining unit 378 confirms the authenticity of the position information (a) received. In this case, the process proceeds to S1504.

Here, for example, the position information (a) and the position information (b) are as follows. Both of these information sets match completely, so that the authenticity of the position information (a) received may be confirmed.

Position information (a)/floor number 16; latitude 35.499555; longitude 139.38711; building number C;

Position information (b)/floor number 16; latitude 35.499555; longitude 139.38711; building number C.

In step S1504, the control unit 374 stores and registers in the storage unit 366, as the position information management information, the identification information and the position information (a) received. The process of the above-described step corresponds to S816 in FIG. 8. In this way, on the management server 160-2, it is possible to display, on a screen, a position, etc., of the wireless terminal 120 (FIG. 9B, for example). Here, in other words, the wireless terminal 120 is displayed to be currently positioned at floor number 16; latitude 35.459555; longitude 139.38711; and building number C.

On the other hand, when the position information (a) and the position information (b) do not match and authenticity of position information (a) received is not confirmed (cannot be confirmed) in step S1503, the process proceeds to S1505, so that a process at the time of no match is carried out.

When the position information (a) and the position information (b) do not match, it means that, while the position information (b) was initially stored by an administrator, etc., in the storage unit 300 of the communication apparatus 100, it was subsequently replaced with the position information (a). In this case, authenticity of position information transmitted by the communication apparatus 100 and authenticity of a position at which the wireless terminal 120 is present cannot be secured.

Here, for example, if the received position information (a) and position information (b) are as follows, these position information sets do not match completely (the floor numbers do not match), so that authenticity of the received position (a) received cannot be determined. In this case, it is considered that the floor number has been rewritten for the position information (a) of the communication apparatus.

Position information (a)/floor number 17; latitude 35.459555; longitude 139.38711; building number C;

Position information (b)/floor number 16; latitude 35.459555; longitude 139.38711; building number C;

In step S1505, the management server 160-2 carried out a process at the time of a non-match as a process at the time of the non-match. In particular, for example, the following processes (measures) may be carried out,

(Exemplary Measure 1)

As a process when there is no match, the management server 160-2 displays, on a screen, a communication apparatus 100 for which authenticity of position information cannot be secured, out of communication apparatuses 100 under control of the management server 160-2. As a display method, a communication apparatus name and a specific ID of the communication apparatus 100 may be displayed on a screen. Moreover, the communication apparatus 100 may be visually reported, such as changing a color of the communication apparatus 100 arranged on a map, etc.

Moreover, the management server 160-2 may perform the same sort of reporting by e-mails and messages to a mobile terminal, a PC, etc., of an administrator, etc.

In this way, the administrator, etc., may notice a failure thereof, such as position information of the communication apparatus 100 actually attached to a ceiling, etc., being rewritten.

(Exemplary Measure 2)

Moreover, as a process when there is no match, the management server 160-2 issues a specific operation control signal (command) via a network to a communication apparatus 100 for which authenticity of position information cannot be secured. A communication apparatus 100 which received the operation control signal may perform various operations in accordance with an operation control signal, such as stopping operations (turning off power), turning on a failure lamp, deleting position information 302 stored in the storage unit 300, issuing an abnormal tone, etc.

In this way, the administrator, etc., or the user, may notice a failure thereof, such as position information of the communication apparatus actually attached to a ceiling, etc., being rewritten, for example.

(Exemplary Measure 3)

Moreover, as a process when there is no match, the management server 160-2 issues a position information rewriting instruction with authentic position information via a network to a communication apparatus 100 for which authenticity of position information cannot be secured. The communication apparatus which received the position information rewriting instruction together with the authentic position information rewrites the position information 302 stored in the storage unit 300 to the received authentic position information, for example. As a matter of course, authentic position information transmitted by the management server 160 is position information (b) registered in the communication apparatus management information 376 with which comparison and matching are made.

In this way, even when the position information of the communication apparatus which is actually attached to the ceiling, etc., is rewritten, it is immediately rewritten to the position information whose authenticity is secured, so that the authenticity of the position information of the communication apparatus 100 may be secured again.

(Exemplary Measure 4)

Moreover, as a process when there is no match, the management server 160-2 issues, via a network, an authenticity unsecured signal which shows authenticity of position information being unsecured to a communication apparatus 100 which cannot secure authenticity of position information. When subsequently transmitting the position information 302 stored in the storage unit 300, the communication apparatus 100 which received the authenticity unsecured signal transmits position information 302 including information which indicates the authenticity being unsecured.

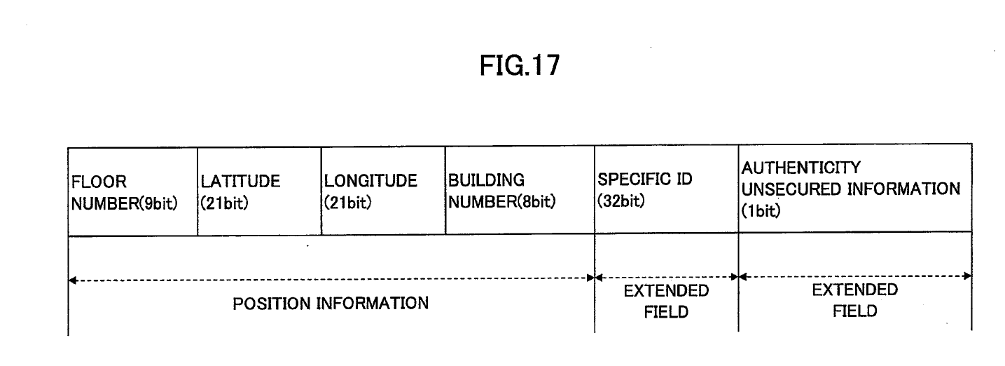

FIG. 17 is a diagram showing an example of an extended format including position information to be transmitted and received between a communication apparatus 100 and a wireless terminal 120 in the present embodiment 2. As seen from a comparison with FIG. 12, in the extended format, respective fields of “authenticity unsecured information” as well as the floor number, latitude, longitude, building number, and specific ID are respectively expressed in 9 bits, 21 bits, 21 bits, 8 bits, 32 bits, and 1 bit. In other words, the communication apparatus 100 which received the authenticity unsecured signal transmits the position information 302 which includes an extended field “authenticity unsecured information”: 1 (1 bit) when subsequently transmitting the position information 302 stored in the storage unit 300.

Then, in the position information management system 1, a wireless terminal 120, a management server 160-2, etc., which have received the position information 302 including the extended field “authenticity unsecured information”: 1 (1 bit) handle the position information as unreliable.

This makes it possible, when the position information of the communication apparatus 100 actually attached to the ceiling, etc., is rewritten, for example, to handle the position information of the communication apparatus 100 as unreliable in the position information management system 1.

The above-described exemplary measures 1 through 4 can also be carried out by combining multiple measures as needed. For example, the exemplary measures 1 and 2 may be carried out, immediately followed by carrying out the exemplary measure 3. Moreover, for example, the exemplary measures 1 and 2 may be carried out, immediately followed by carrying out the exemplary measure 4.

As described above, the present embodiments make it possible to provide a position information management system, etc., which efficiently manage position information. The present invention is not to be limited to specific embodiments, so that variations and changes are possible within the scope of the present invention as recited in the claims.

The present application is based on Japanese Priority Application No. 2012-120204 filed on May 25, 2012, the entire contents of which are hereby incorporated by reference.

1. A position information management system, comprising: a communication apparatus which includes a storage unit which stores therein position information of the communication apparatus; a wireless terminal which includes identification information and which communicates with the communication apparatus; and a management server which manages a position of the wireless terminal, wherein the management server further includes
a position information receiving unit which receives the identification information and the position information from the communication apparatus;
a storage unit which stores the position information of the communication apparatus and registered position information of the communication apparatus;
a determining unit which determines whether the position information received by the position information receiving unit and stored in the storage unit and the registered position information match; and
a management unit which manages the position of the wireless terminal with the identification information and the position information that is determined to match by the determining unit.

2. The position information management system as claimed in claim 1, wherein the communication apparatus includes
a position information transmitting unit which transmits the position information stored in the storage unit to the wireless terminal;
a terminal information receiving unit which receives the identification information and the position information from the wireless terminal which received the position information;
and a terminal information transmitting unit which transmits the position information and identification information that are received by the terminal information receiving unit to the management server, and wherein the wireless terminal includes
a position information receiving unit which receives the position information from the communication apparatus; and
an identification information transmitting unit which transmits to the communication apparatus, together with the position information, identification information of the wireless terminal.

3. The position information management system as claimed in claim 2, wherein the management server includes a registration unit which stores, in the storage unit, results of collating the communication apparatus, and the registered position information of the communication apparatus, and wherein
the registered position information which is registered in the registration unit is position information for which there is determined a match with position information stored in the storage unit of the communication apparatus.

4. The position information management system as claimed in claim 2, wherein
the management server reports a communication apparatus which has transmitted the position information when it is not determined by the determining unit that there is a match, and wherein the report includes an e-mail report or a message to a predetermined terminal and a report by changing a display state of an identifier of the communication apparatus arranged on a map, or a report by displaying of an identifier of the communication apparatus on a screen.

5. The position information management system as claimed in claim 2, wherein the management server transmits an operation control signal to the communication apparatus which has transmitted the position information when it is determined by the determining unit that there is not a match, and wherein the communication apparatus carries out operation control of the communication apparatus in accordance with the operation control signal, and the operation control includes stopping operations, turning off power, turning on a failure lamp, deleting the position information stored in the storage unit of the communication apparatus, or issuing an abnormal tone.

6. The position information management system as claimed in claim 2, wherein
when it is determined by the determining unit that there is not a match, the management server transmits the registered position information to the communication apparatus which has transmitted the position information, and wherein
the communication apparatus rewrites position information stored in the storage unit to be the registered position information transmitted from the management server.

7. The position information management system as claimed in claim 2, wherein the management server transmits a signal indicating authenticity being unsecured for the position information to the communication apparatus which transmitted the position information when it is determined by the determining unit that there is not a match, and wherein the position information transmitting unit of the communication apparatus transmits the position information including the signal to the wireless terminal after receiving the signal.

8. A position information management method in a position information management system, the system including a storage unit which stores position information of the communication apparatus; a wireless terminal which includes identification information and which communicates with the communication apparatus; and a management server which manages a position of the wireless terminal, wherein the management method further includes the steps of:
receiving the identification information and the position information from the communication apparatus;
obtaining, from the storage unit which stores the position information of the communication apparatus and registered position information of the communication apparatus, the registered position information of the communication apparatus which has transmitted the position information received by the position information receiving unit and stored in the storage unit;
determining whether there is a match between the registered position information and the position information received by the position information receiving unit; and
managing a position of the wireless terminal with the identification information and the position information that is determined to match by the determining unit.

9. A management server which is connected with a communication apparatus including a storage unit which stores therein position information of the communication apparatus, and a wireless terminal which includes identification information, which management server communicates with a communication apparatus, and manages a position of the wireless terminal, the management server comprising:
a position information receiving unit which receives the identification information and position information from the communication apparatus;
a storage unit which stores the position information of the communication apparatus and registered position information of the communication apparatus;
a determining unit which determines whether the position information received by the position information receiving unit and stored in the storage unit and the registered position information match; and
a management unit which manages the position of the wireless terminal with the identification information and the position information that is determined to match by the determining unit.
